(19) United States
(12) Patent Application Publication
(10) Pub. No.: US 2024/0403885 A1
(43) Pub. Date: Dec. 5, 2024

(54) AUTOMATED FRAUD RISK ASSESSMENT SYSTEMS AND METHODS

(71) Applicant: Citibank, N.A., New York, NY (US)

(72) Inventors: Jeffrey Brian BASHORE, St. Augustine, FL (US); Charles Hoonchul KIM, Parker, CO (US); John William ERICKSON, Crestwood, KY (US)

(73) Assignee: Citibank, N.A., New York, NY (US)

(21) Appl. No.: 18/733,811

(22) Filed: Jun. 4, 2024

Related U.S. Application Data
(63) Continuation of application No. 15/911,559, filed on Mar. 5, 2018, now abandoned.

(51) Int. Cl. G06Q 20/40; G06N 20/00

(52) U.S. Cl. CPC G06Q 20/4016; G06N 20/00; G06F 2216/03

(57) ABSTRACT

Systems and methods involve an automated risk assessment platform server that receives data regarding a potential fraudulent account event from a fraud detection platform processor and a data mining function that extracts additional data related to the potential fraudulent account event from a plurality of data sources. An artificial intelligence engine function enhances the additional data for further processing, and a pattern recognition function searches the data for one or more data patterns that indicate whether or not the account event is fraudulent and generates a treatment recommendation when at least one data pattern is found that indicates that the account event is fraudulent.

### CROSS-REFERENCE TO RELATED APPLICATIONS

This application is a continuation of U.S. application Ser. No. 15/911,559, filed Mar. 5, 2018. The content of the foregoing application is incorporated herein in its entirety by reference

### FIELD OF THE INVENTION

The present invention relates generally to the field of automated risk assessment, and more particularly to automated systems and methods for fraud risk assessment.

### BACKGROUND OF THE INVENTION

Currently, detecting fraud and processing fraud cases may comprise a detection engine and a primarily manual risk assessment process of validating a probability of actual fraud and determining a resolution path. The current risk assessment process may be characterized as based on one or more judgmental decisions, for example, after a review of structured and unstructured data from an account history and third party information. Thus, such legacy fraud processing may typically involve one or more manual operations.

An account event may be a monetary event, such as an authorization and payment event, or a non-monetary event, such as an account update event including the channel used in the event, which may be noted and sent to a detection engine for potential fraud review. In legacy fraud operations, there may be, for example, three distinct phases of fraud processing. A first phase may be fraud detection, which may employ certain technologies capable of detecting fraud that are commercially available from various vendors.

The fraud detection phase may involve, for example, a process for detecting potential fraud, including assigning a probability of such fraud, using algorithms and pattern recognition based on existing industry data, monetary and non-monetary client transaction data, and client profile data based on client usage characteristics. Presently, a possible fraud request phase may result, for example, in a conditional approval of an authorization request, or a fraud case may be created based on non-monetary activity on a client account. The fraud request phase may also result, for example, in a decline of an authorization request for possible fraud reasons or an approval of an authorization request when no fraud is indicated.

When a probability of fraud is detected, a second phase in legacy fraud processing may be a risk assessment process. A current pre-indicator risk assessment process may involve an initial review to determine the validity of a potential fraud case. Possible outcomes of such a risk assessment process may include, for example, a potential fraud determination, requiring a further evaluation, or a determination that no fraud was identified.

In a legacy account activity and identity verification risk assessment process phase, if a possible fraud case determination is deemed valid, additional data from disparate sources may be reviewed to determine the validity of the fraud case. Currently, in many financial services organizations such a review may be a manually based on an agent's judgmental experience and information reviewed by the agent. Thus, the risk assessment process may involve human judgment in assessing whether or not the detected activity is actually fraudulent. Such manual assessment process may involve, for example, attempting to determine if the activity is definitely fraud or if it is sufficiently suspicious to warrant a further investigation to confirm definitively whether or not it is fraud.

When a determination is made that an activity is sufficiently suspicious to warrant a further investigation, a third phase in legacy fraud processing may be a treatment plan process. The treatment plan phase may involve, for example, prescribing a resolution path for the potential fraud case to its closure based upon the risk assessment phase information using manual processing when human intervention is required. Such closure may involve, for example reaching a final determination of whether or not an activity is fraudulent, for example, by actually speaking with the account holder or verifying particular facts about the activity in order to make such a final determination. Following the case processing phase, a post decision review phase may include, for example, a manual process of evaluating decisions made throughout the process to understand the effectiveness of the overall process.

There is a present need for automated fraud risk assessment systems and methods that perform fraud determination via artificial intelligence that employs, for example, machine learning, intelligent search, and pattern recognition, which eliminates or minimizes a need for human judgmental decisioning and thus overcome the deficiencies of these legacy systems. The problem solved by embodiments of the invention is rooted in technical and human limitations of the legacy approaches, and improved technology is needed to address the problems of currently employed approaches. More specifically, the aforementioned legacy approaches fail to achieve the sought-after capabilities of the herein-disclosed automated fraud risk assessment systems and methods.

These and other aspects of the invention will be set forth in part in the description which follows and in part will become more apparent to those skilled in the art upon examination of the following or may be learned from practice of the invention. It is intended that all such aspects are to be included within this description, and are to be within the scope of the present invention, and are to be protected by the accompanying claims.

### SUMMARY OF THE INVENTION

Embodiments of the invention advance technical fields for addressing problems associated with the above described legacy manual processes for fraud risk assessment as well as advancing peripheral technical fields. Such embodiments of the invention employ computer hardware and software, including, without limitation, one or more processors coupled to memory and non-transitory computer-readable storage media with one or more executable programs stored thereon which instruct the processors to perform the automated fraud risk assessment described herein.

Embodiments of the invention are directed to technological solutions that may involve automated systems that may employ, for example, an automated risk assessment platform server having a processor coupled to memory and being programmed to receive data regarding a potential fraudulent account event from a fraud detection platform processor; a data mining function of the risk assessment platform server processor that extracts additional data related to the potential fraudulent account event from a plurality of data sources; an artificial intelligence engine function of the risk assessment platform server processor that enhances the additional data for further processing; and a pattern recognition function of the risk assessment platform server processor that searches the received and enhanced additional data for one or more data patterns which indicate whether or not the account event is fraudulent and generates a treatment recommendation when at least one data pattern is found that indicates that the account event is fraudulent.

Further aspects of embodiments of the invention may employ, for example, a segregation function of the risk assessment platform server processor that segregates the received data regarding the potential fraudulent account event into a portfolio type grouping and a fraud type grouping. In other aspects, the segregation function of the risk assessment platform server processor may segregate the received data regarding the potential fraudulent account event into the portfolio type grouping comprising, for example, at least one of branded cards type, retail services type, and retail bank type. In still other aspects, the segregation function of the risk assessment platform server processor may segregate the received data regarding the potential fraudulent account event into the fraud type grouping comprising, for example, at least one of account takeover type, never received issues type, transaction type, and identification type.

Additional aspects of embodiments of the invention may employ, for example, a treatment execution function of the risk assessment platform server processor that receives and executes the treatment recommendation. In other aspects, the treatment execution function of the risk assessment platform server processor may execute the treatment recommendation by taking or withholding at least one action to resolve the fraudulent account event. Still other aspects may employ, for example, a treatment results function of the risk assessment platform server processor that generates one or more recommendations for improving the automated risk assessment platform based at least in part on the treatment recommendation.

In additional aspects of embodiments of the invention, the data mining function of the risk assessment platform server processor may extract additional data related to the potential fraudulent account event from the plurality of data sources comprising, for example, at least one of credit reporting agency data systems, interactive voice response services systems, account activity data, customer records, transaction records, agent notes, and system notes. In other aspects, the data mining function of the risk assessment platform server processor may extract the additional data related to the potential fraudulent account event comprising, for example, structured data and unstructured data related to the potential fraudulent account event from the plurality of data sources.

In further aspects of embodiments of the invention, the data mining function of the risk assessment platform server processor may extract the structured data related to the potential fraudulent account event comprising, for example, labeled data from at least one of the plurality of data sources. In still further aspects, the data mining function of the risk assessment platform server processor may extract the structured data related to the potential fraudulent account event comprising, for example, at least one of address change data, phone number data, authorized users data, mail address data, and new card request data from the plurality of data sources. In additional aspects, the data mining function of the risk assessment platform server processor may extract the unstructured data related to the potential fraudulent account event comprising, for example, at least one of agent notes, system notes, and system logs from the plurality of data sources.

In other aspects of embodiments of the invention, the artificial intelligence engine function of the risk assessment platform server processor may enhance the additional data for further processing by formatting data defined by predefined system protocols, labeling unstructured data, searching and identifying characteristics of data for inclusion within labeled data, searching and identifying data patterns, and enhancing labeled data to provide metadata elements for further processing. In still other aspects, the artificial intelligence engine function of the risk assessment platform server processor may enhance the additional data comprising at least one of transaction activity data, transaction velocity data, and transaction communication data for further processing.

In still other aspects of embodiments of the invention, the pattern recognition function of the risk assessment platform server processor may search the received and enhanced additional data for one or more data patterns comprising, for example, transaction activity data patterns, transaction velocity data patterns, and transaction communication data patterns that indicate that the account event is fraudulent. In further aspects, the pattern recognition function of the risk assessment platform server processor may search the received and enhanced additional data for one or more data patterns comprising, for example, patterns of dates and times of notations of account activity over a pre-determined period that indicate that the account event is fraudulent.

Embodiments of the invention may also provide methods involving, for example, receiving, by an automated risk assessment platform server having a processor coupled to memory, data regarding a potential fraudulent account event from a fraud detection platform processor; extracting, by a data mining function of the risk assessment platform server processor, additional data related to the potential fraudulent account event from a plurality of data sources; enhancing, by an artificial intelligence engine function of the risk assessment platform server processor, the additional data for further processing; and searching, by a pattern recognition function of the risk assessment platform server processor, the received and enhanced additional data for one or more data patterns that indicate whether or not the account event is fraudulent and generating a treatment recommendation when at least one data pattern is found that indicates that the account event is fraudulent.

Other aspects of the method for embodiments of the invention may involve, for example, segregating, by a segregation function of the risk assessment platform server processor, the received data regarding the potential fraudulent account event into a portfolio type grouping and a fraud type grouping. Still other aspects may involve, for example, receiving and executing, by a treatment execution function of the risk assessment platform server processor, the treatment recommendation. Additional aspects may involve, for example, generating, by a treatment results function of the risk assessment platform server processor, one or more recommendations for improving the automated risk assessment platform based at least in part on the treatment recommendation.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic flow chart that illustrates an overview example of an automated fraud risk assessment process and treatment plan determination for embodiments of the invention;

FIG. 2 is a schematic diagram that illustrates an example of a processing model in an automated risk assessment system for embodiments of the invention;

FIG. 3 is as table showing examples of types of data obtained from data mining by the automated system for embodiments of the invention;

FIG. 4 is a table that illustrates examples of types of data that may be enhanced from the data mining by the automated system for embodiments of the invention;

FIG. 5 is a table that illustrates examples of dates and times of notations for a hypothetical account in a three-month period in embodiments of the invention;

FIG. 6 is a graph showing a plot of hypothetical examples of notations of occurrences of balance inquiries on the X-axis versus times at which such balance inquiries were made on the Y-axis for embodiments of the invention;

FIG. 7 is a graph showing a plot of hypothetical examples of notations of occurrences of balance inquiries on the X-axis versus number of days between such balance inquiries on the Y-axis for embodiments of the invention;

FIG. 8 is a schematic diagram that illustrates an example of a processing model in a simple use case of a possible account takeover in the automated system for embodiments of the invention; and

FIGS. 9A through 9F show a table that illustrates examples of unstructured data and structured data for mining and analysis by the automated system for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Embodiments of the invention provide an automated process for fraud risk assessment and treatment of a fraud determination process via artificial intelligence, employing, for example, machine learning, intelligent search, and pattern recognition. As noted, the legacy risk assessment processing employs human judgment to determine the validity of fraud cases and to identify a resolution path, referred to as “treatment.” Thus, embodiments of the invention provide improved technology for automating fraud case processing, for example, within the financial services industry that eliminate or minimize a need for currently employed human judgmental decisioning as part of the risk assessment process,

In embodiments of the invention, the fraud risk assessment process may involve, for example, collecting both structured and unstructured data. Such structured data may include, for example, a number of transactions attempted or made by a client over a particular time period, a number of contacts made by the client to service the clients' account, the nature of the client's spending habits, and/or the client's payment activities. Unstructured data, which may typically be found, for example, in a client's historical servicing notes, may by useful in attempting to ascertain the nature of the client's interactions.

A fraud risk assessment process for embodiments of the invention may require evaluation of structured data, such as account information and third party data, as well as evaluation of unstructured data, such as notes regarding a client's service history, voice analytics, and other free-form information, to make a decision to further investigate and determine a resolution method. Embodiments of the invention employ a unique approach to fraud risk assessment that employs artificial intelligence and machine learning to mine the unstructured data and convert that data into structured data, which can be used with pattern recognition engines to eliminate a need for human decisions.

An aspect of embodiments of the invention may use such structured and unstructured data and employ artificial intelligence to search for specifically known fraud patterns. Such patterns may be revealed, for example, in velocity of contacts between a client and the business, the nature or subject matter of such contacts, as well as a number of failed attempts in authenticating by the client. In embodiments of the invention, the risk assessment process may be automated via methods and processes, such as system communication protocols, intelligent data mining with machine learning and artificial intelligence, and pattern recognition with machine learning.

In embodiments of the invention, system communication protocols may include both integrated and nonintegrated system communication protocols. Such integrated system communication protocols may include, for example, Extract, Transform, Load (ETL) protocol that enables extraction of data from source systems, transformation of the data to prepare it for an end target, and loading the data into the end target system. Other such integrated system communication protocols may include, for example message queue protocol that enables messaging patterning in which collections of message data may be sent to a queue of a target system via a communication network to be consumed in an asynchronous manner, as well as publish/subscribe protocol that enables messaging patterning in which a message is published and zero, one, or many receivers or subscribers may obtain the published message.

Additionally, in embodiments of the invention, nonintegrated system communication protocols may include, for example, a software robotics application that replaces actions of a human with a user interface of a computer system to interact with, and acquire data from, disparate systems, such as screen scrapings and web scrapings, without a need to integrate with those systems. It is to be understood that the foregoing references to specific integrated and nonintegrated system communication protocols are exemplary and non-exhaustive and that other communication protocols may be leveraged to obtain data from integrated and nonintegrated systems for the aforementioned purposes, as well.

In addition to the use of artificial intelligence, embodiments of the invention may also employ advanced data mining techniques, for example, to understand the nature of interactions between a client and the business. Intelligent data mining with machine learning and artificial intelligence employed in embodiments of the invention may provide a method for analyzing unstructured data for certain patterns and converting that unstructured data to structured form.

In embodiments of the invention, such intelligent data mining with machine learning and artificial intelligence may also provide a method for analyzing the unstructured data for previously unidentified patterns and likewise converting that unstructured data to structured form. Examples of unstructured data may include a servicing history in terms of system notes related to the client or the account. Another example of such unstructured data may include a voice recording system used to record all the inbound and outbound telephone calls received or made by the business regarding the client's account.

Pattern recognition with machine learning employed in embodiments of the invention may provide a method for computer-generated judgmental decisions based on training or machine learning and patterns associated with specific outcomes. In embodiments of the invention, once such structured and unstructured data is assembled, the data may be processed through a recognition engine where the data may be configured such that a determination may be made on whether or not a particular activity constitutes fraud. A possible outcome may be that there is no fraud, whereupon the case may be closed and the client may be allowed to proceed without any disruption.

On the other hand, if the outcome points to a suspicion that there is fraud, embodiments of the invention may employ a recognition engine to perform a treatment plan based on the investigation result. For example, in embodiments of the invention, the data relating to the history of transactions with the client, which is known to the business, may be mined. Thus, such data may be assembled by the artificial intelligence engine, which may either present an output recommending a manual investigation or pointing to an automated self-service process for the client.

Automated risk assessment process and treatment plan determination for embodiments of the invention may commence with gathering data from disparate sources. Such gathering of data may employ artificial intelligence, robotics, and data mining tools to acquire the data from the disparate sources. For example, robotics may be employed in connection with gathering data from historic sources without necessitating the expense of fully integrating with one or more data sources. Thus, such robotics, in combination with the aspects of intelligent data mining based on artificial intelligence, enables gathering unstructured data and generating a structured output with which embodiments of the invention provide answers regarding possible fraud.

Thereafter, the automated fraud risk assessment process for embodiments of the invention may involve, for example, executing computer-based judgmental processes for determining the validity of the fraud case and prescribing one or more resolutions using automation channels, algorithms based, for example, on statistical data and probability of certain events occurring, and pattern recognition using an artificial neural network with broader sets of data than used within the detection phase. A further aspect of embodiments of the invention may involve, for example, employment of a pattern recognition engine with machine learning to generate a decision for a particular activity as being potentially fraudulent or not fraudulent. If the decision is that the activity is potentially fraudulent, the pattern recognition engine may also generate a recommendation to remediate or fully investigate the case to closure.

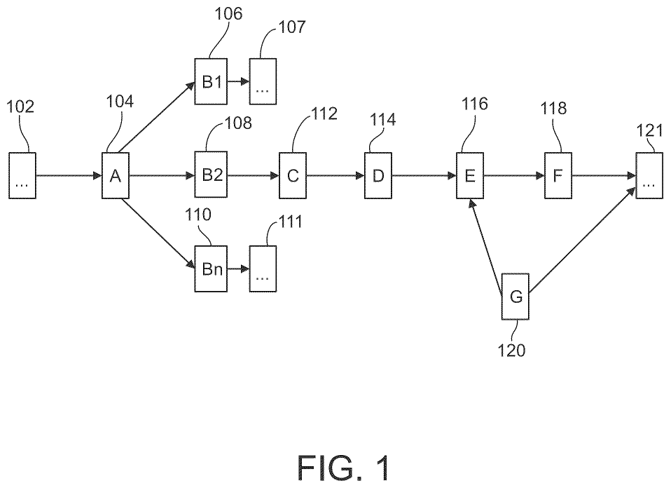

FIG. 1 is a schematic flow chart that illustrates an overview example of an automated risk assessment process and treatment plan determination for embodiments of the invention. Referring to FIG. 1, detection 102 of potentially fraudulent activity may result from identification by the fraud detection platform of a usage pattern that does not conform to a past usage pattern of a particular client. Referring further to FIG. 1, the automated risk assessment process for embodiments of the invention may involve, for example, segregating 104 inputs from the detection engine into meaningful groupings 106, 108, 110 and processing those inputs according to such groupings.

Referring again to FIG. 1, in embodiments of the invention, groupings may include, for example, a portfolio group 106, such as branded cards, retail service, and/or retail bank; and a fraud type group 108, such as account takeover (ATO), never received issues (NRI), and transaction type. Thus, the fraud detection output 102 may be a portfolio type, such as branded cards, and a fraud type, such as an account takeover type of fraud in which unauthorized parties are attempting to take over an existing account of a client.

In embodiments of the invention, the fraud detection platform output may also include, for example, a probability score for a particular type of fraud, such as a simple transaction fraud, that facilitates sending the matter to an automated channel for embodiments of the invention. For example, such an automated channel may be communication/contact management center queue that may generate a communication, for example, via text message, email, or voice call to the client. Such communication may simply ask the client to confirm that the detected transaction is being performed, or is authorized, by the client. When confirmed by the client, no fraud is indicated, and an authorization for the transaction may be approved.

Referring still further to FIG. 1, at 112, data mining for structured data and/or unstructured data related to an input in the form of data acquisition through integration and/or robotics may be employed in embodiments of the invention. Such structured data may include, for example, new card requests and address change data and unstructured data may include, for example, system notes regarding a client and/or inbound and outbound client telecommunication data. Referring again to FIG. 1, in a data analysis and mining process 114, intelligent data mining with machine learning and artificial intelligence may be performed.

In a more complicated case of a potential fraud detected by the detection platform, the data mining aspect for embodiments of the invention may use either integration or robotics to gather structured and/or unstructured data related to the client and the account. In the data analysis and mining process 114, structured data may be transformed, for example, by correcting typos and confirming and enforcing formatting requirements, and unstructured data may be searched using intelligent search engines based upon artificial intelligence to identify patterns (e.g., pass, fail), velocity of activity (e.g., communications, communication channels, transactions), failure to meet demographics, and nature of contact history.

In the data analysis and mining aspect 114 for embodiments of the invention, the structured data may be transformed into an appropriate format if necessary, and the unstructured data may be mined using one or more intelligent search engines based upon machine learning and artificial intelligence. Examples of unstructured data may include, for example, fail/pass client identification patterns, velocity of client account activity, client demographics, and nature of client contact history. For example, in a suspected account takeover attempt, the objective of mining the data may be to use different variations of a search to mine the data and identify key attributes of the client's account. Based on such information, embodiments of the invention may employ a pattern recognition engine to analyze the outcomes of the segregation, data mining, and data analysis and mining aspects of embodiments of the invention.

Referring also to FIG. 1, at 116, a pattern recognition process may objectively and independently address unique questions with each network optimized for a unique question, such as “Is it fraud?”, “What is a recommended treatment action?”, and/or “What is a recommended communication strategy?”. At 118, types of case processing may include, for example, fraud or not fraud, and at 120, a results process may involve, for example, a post-decision review of an outcome of fraud or not fraud and post-decision review regarding process enhancements.

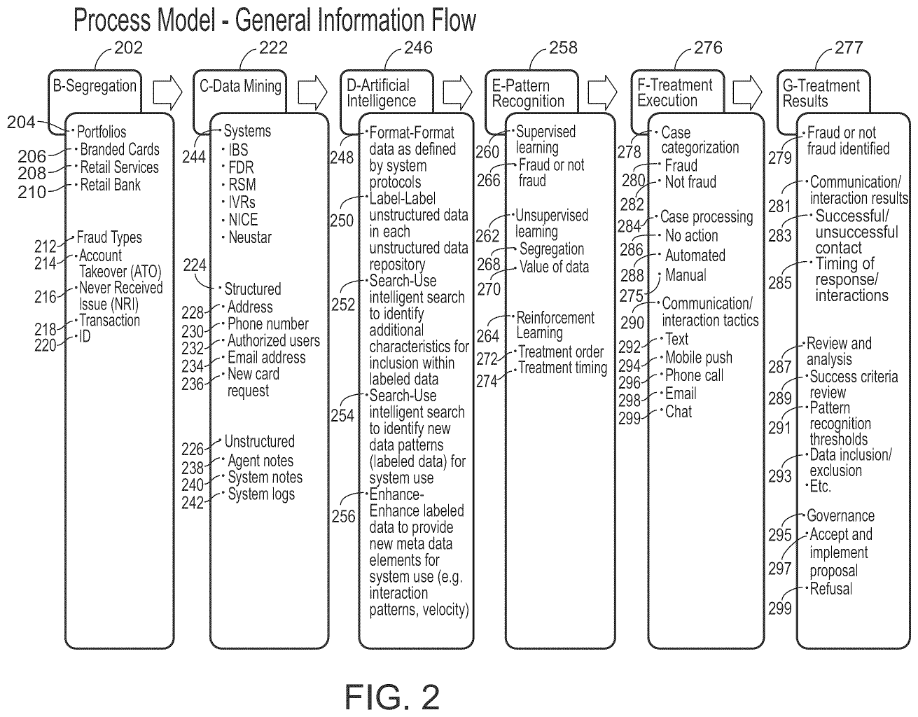

FIG. 2 is a schematic diagram that illustrates an example of a processing model in an automated risk assessment system for embodiments of the invention. It is to be understood that the example of FIG. 2 is not comprehensive in nature but is intended as an illustration at a high level of an automated process that may be performed according to embodiments of the invention. Referring to FIG. 2, segregation at 202 may be a process of setting an activity and/or account apart from other activities and/or accounts for the purpose of obtaining optimal (i.e., minimal) fraud loss and adhering to all business rules. It is to be understood that the segregation process 202 may not be a required step but may be used for process enhancement and optimization. In the segregation process 202 for embodiments of the invention, groupings may include, for example, a portfolio group 204, such as branded cards 206, retail services 208, and/or retail bank 210, and a fraud type group 212, such as account takeover (ATO) 214, never received issues (NRI) 216, transaction type 218 and identification 220.

Referring further to FIG. 2, in embodiments of the invention, data mining at 222 may be a process of extracting information from disparate systems and sources, and transforming the data into an understandable structure for analysis, assessment, treatment, and other uses. In embodiments of the invention, data mining 222 may be performed on two groups of data, namely structured data 224 and unstructured data 226. Structured data 224 may include, for example, address change data 228, phone number data 230, authorized users data 232 email address data 234, and new card request data 236. Structured data 224 may include, for example, labeled data from another system to be used by the fraud risk assessment automation system for embodiments of the invention. Structured data 224 may be used, but is not required, to create metadata for analysis and decisions.

Referring again to FIG. 2, unstructured data 226 may include data obtained, for example, from a system that must be labeled and/or enhanced in order to be used by the fraud risk assessment automation system for embodiments of the invention. Such unstructured data 226 may include, for example, agent notes 238 and system notes 240, and system logs 242 regarding a client and/or inbound and outbound client telecommunication data. Enhanced unstructured data may be used, but is not required, to create metadata for analysis and decisions. Unstructured data may be used to create one or many enhanced data elements to be used by the fraud risk assessment automation system for embodiments of the invention.

Referring once again to FIG. 2, many systems 244 may be employed as sources from which to obtain structured 224 and unstructured 226 data for the fraud risk assessment automation system for embodiments of the invention. Sources of such data may include, but is not limited to, third party data systems, such as TRANSUNION, EXPERIAN, and EQUIFAX, third party service systems, such as NICE voice services and USAN interactive voice response services, activity data, such as system notations, logs, and transactions, and internal data and servicing systems, such as customer records, transaction records, agent notes, and system notes.

In the data mining process 222 for embodiments of the invention, structured data 224 may be transformed, for example, by formatting data defined by system protocols (e.g., correcting typos and confirming and enforcing formatting requirements), labeling unstructured data in each unstructured data repository, searching data using intelligent search to identify new data patterns in labeled data for use in the automated system for embodiments of the invention, and enhancing labeled data to provide new metadata elements (e.g., interaction patterns, velocity) for such system use.

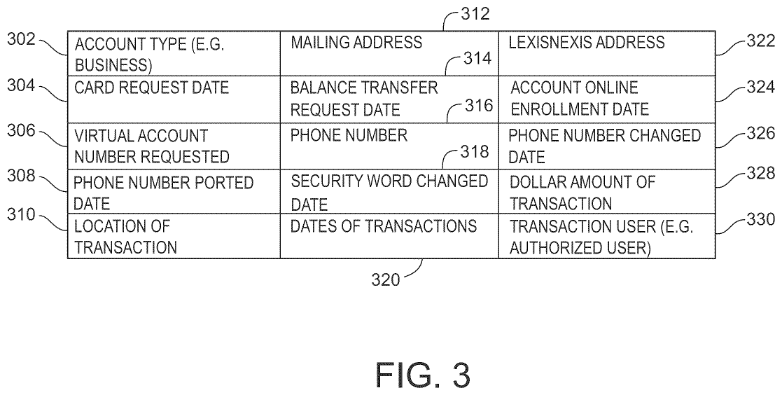

FIG. 3 is as table showing examples of types of data obtained from data mining 222 by the automated system for embodiments of the invention. Referring to FIG. 3, such types of data may include, for example, account type (e.g. business) 302, card request date 304, virtual account number requested 306, phone number ported date 308, location of transaction 310, mailing address 312, balance transfer request date 314, and phone number 316. Other such data types may include, for example, security word change date 318, dates of transactions 320, LEXISNEXIS address 322, online account enrollment date 324, phone number change date 326, dollar amount of transaction 328, and transaction user 330 (e.g. authorized user). It is to be understood that such data types are exemplary only and that embodiments of the invention are not limited to such examples.

Referring again to FIG. 2, artificial intelligence 246 for the automated risk assessment process of embodiments of the invention may provide functions of performing analysis, pattern recognition, learning, and problem solving. Thus, in embodiments of the invention, one or more artificial intelligence modules may be employed to obtain and/or enhance structured and unstructured data for use by the automated system. Examples of tasks for which artificial intelligence 246 may be used in embodiments of the invention may include, without limitation, formatting data defined by system protocols 248, labeling unstructured data in each unstructured data repository 250, using intelligent search to identify additional characteristics for inclusion within labeled data 252, using intelligent search to identify new data patterns (e.g., labeled data) for use by the automated system for embodiments of the invention 254, and enhancing labeled data to provide new metadata elements for use by the automated system (e.g., interaction patterns, velocity) 256.

Thus, in embodiments of the invention, artificial intelligence 246 may be used, for example, in formatting and labeling data such that it can be used by the fraud risk assessment automation system in transforming and/or updating data within known bounds (e.g. typo corrections and decimal placement), dates of interactions, algorithm identification and/or enhancement, and system identification status (i.e. pass or fail). Other examples of tasks for which artificial intelligence 246 may be used in embodiments of the invention may include, but are not limited to, velocity of activity (e.g. communication, communication channels used/not used, transactions), demographic alignment (i.e. does/does not meet demographics), nature of contact history, and metadata creation/enhancement

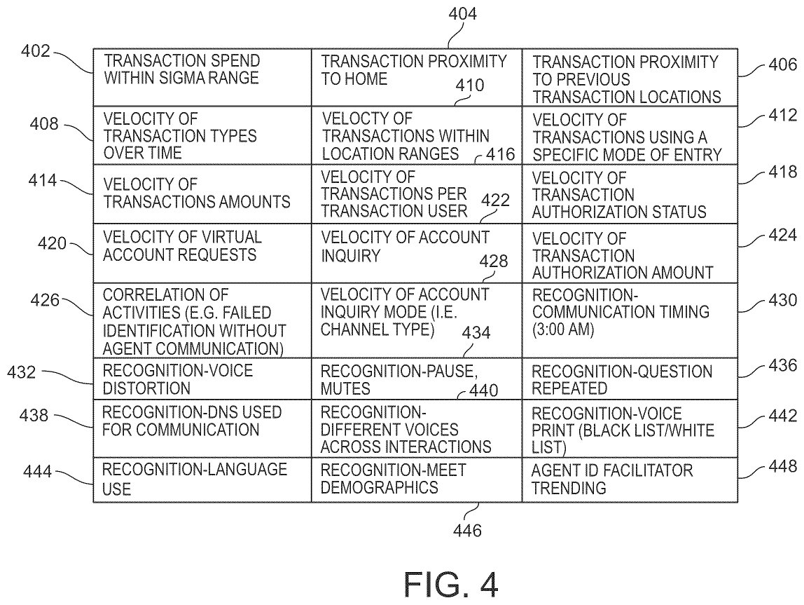

FIG. 4 is a table that illustrates examples of types of data that may be enhanced from data mining by the automated system for embodiments of the invention. Such types of data may include, for example, transaction spend within a sigma range 402, transaction proximity to home 404, transaction proximity to previous transaction locations 406, velocity of transaction types over time 408, velocity of transactions within location ranges 410, velocity of transactions using a specific mode of entry 412, velocity of transactions amounts 414, and velocity of transactions per transaction user 416.

Referring further to FIG. 4, other such types of data may include, for example, velocity of transaction authorization status 418, velocity of virtual account requests 420, velocity of account inquiry 422, velocity of transaction authorization amount 424, correlation of activities (e.g. failed identification without agent communication) 426, velocity of account inquiry mode (i.e. channel type) 428, recognition-communication timing (3:00 AM) 430, and recognition—voice distortion 432. Still other such types of data may include, for example, recognition—pause, mutes 434, recognition—question repeated 436, recognition—DNIS used for communication 438, recognition—different voices across interactions 440, recognition-voice print (black list/white list) 442, recognition—language use 444, recognition—meet demographics 464, and agent ID facilitator trending 448. It is to be understood that such types of data are exemplary only and that embodiments of the invention are not limited to such examples.

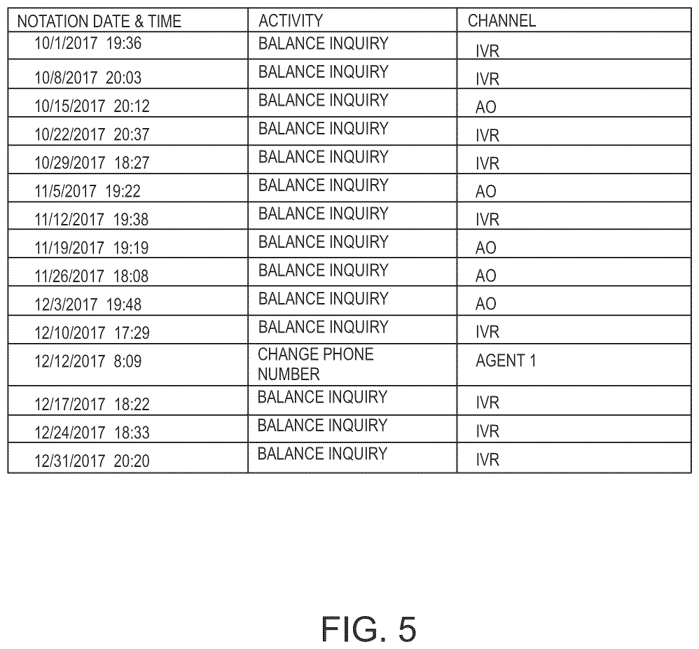

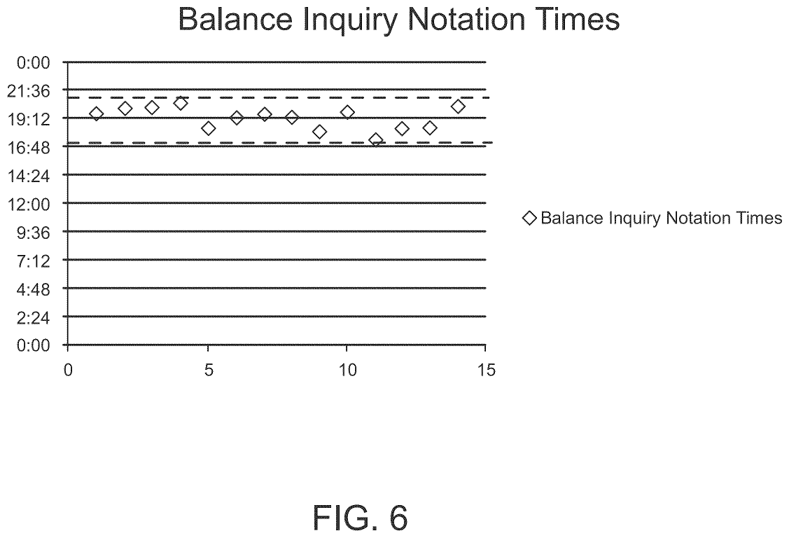

In embodiments of the invention, enhanced data may used to provide additional data points and context for the automated fraud risk assessment system for embodiments of the invention. FIG. 5 is a table that illustrates examples of dates and times of notations for a hypothetical account in a three-month period in embodiments of the invention. FIG. 6 is a graph showing a plot of hypothetical examples of notations of occurrences of balance inquiries on the X-axis versus times at which such balance inquiries were made on the Y-axis for embodiments of the invention.

Referring to FIGS. 5 and 6, the latest time that a balance inquiry notation occurred on any day during this period of time was at 20:37 PM or 8:37 PM, and the earliest time that a balance inquiry notation occurred on any day during this period of time was at 17:29 PM or 5:29 PM. Using statistical methods, control limits (i.e., sigma levels) may be identified for transaction activity outside of a typical use. Assuming that 8:37 PM is the upper control limit identified, and that 5:29 PM is the lower control limit as indicated by the respective dashed lines in FIG. 6, any future transaction activity that occurs after 8:37 PM and before 5:29 PM may indicate an increased probability for fraudulent activity.

Embodiments of the invention may also employ other notation time enhancements. For example, other potential notation time enhancement data points may include, without limitation, using combinations of data groupings with notation time for pattern identification (e.g. notation type, such as balance inquiry, with notation time for pattern identification) and customer initiated activity (e.g., group of activity) occurring outside of control limits.

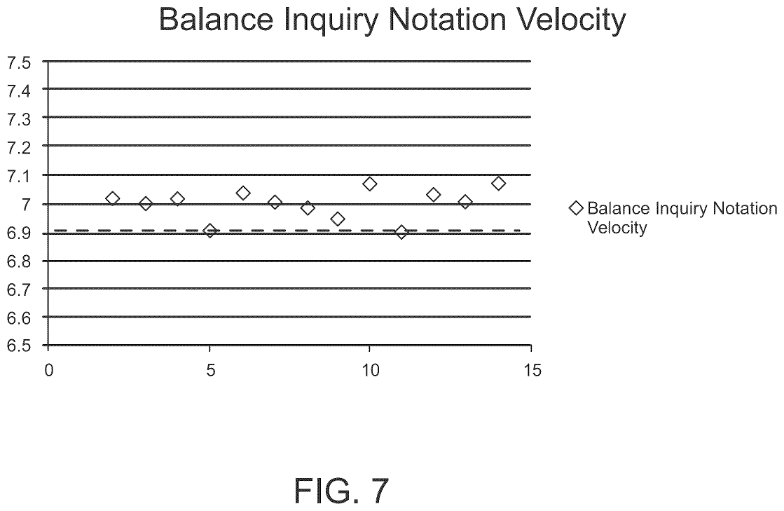

FIG. 7 is a graph showing a plot of hypothetical examples of notations of occurrences of balance inquiries on the X-axis versus number of days between such balance inquiries on the Y-axis for embodiments of the invention. Of the fifteen hypothetical balance inquiry notation examples shown in FIG. 5, there are no instances of more than one balance inquiry notation occurring in one day, and for all other transactions, all balance inquiry notations occur approximately one week apart. Again using statistical methods, a control limit (i.e., sigma level) may be identified for transaction activity outside of typical use. Assuming that 6.9 is the lower control limit identified as indicated by the dashed line on FIG. 7, any future activity for which the velocity count is 6.9 or lower on any specific day that may be an indication of an increased probability for fraudulent activity.

Embodiments of the invention may employ still other notation velocity enhancements. Examples of other potential notation velocity enhancements data points include, without limitation, notation velocity within other granularities of time (e.g., hours, days, week, months, or years), and negative notation pattern identification. For an example of such negative notation pattern identification, in FIG. 5, there are no notation activities at all via a mobile channel. Thus, any future notation activity that may occur via a mobile channel would be a change in the activity pattern, which may indicate an increased probability for fraudulent activity.

For an example of agent notation activity outside of typical use, note that one account change, namely a phone number change on Dec. 12, 2017 at 8:09 PM is shown within the three months of activity in the table of FIG. 5. Using statistical methods, a control limit (i.e., sigma level) may be identified for agent notation activity outside of typical use. An example of a potential agent notation fraud indicator may include, but is not limited to, multiple account changes, by multiple agents, within a statistically significant period of time (e.g., Agent 1 changes the address at time period 1, Agent 2 adds an authorized user at time period 2, and Agent 3 changes the phone number at time period 3).

Referring once more to FIG. 2, pattern recognition 258 in the automated system for embodiments of the invention may focus on recognition of patterns and regularities in data provided to the system. Thus, a pattern recognition module for embodiments of the invention may be employed to provide artificial cognition for action or lack of action, such as “What fields should be used thresholds?”, “What tolerance levels should be specified?”, “What patterns exist for identification?”, “Does the input data indicate fraud?”, “What treatments should be performed based upon the data provided?”, and “What order of treatments should be performed based upon the data provided?”. In embodiments of the invention, multiple patterns may be assessed to perform such artificial cognition, with pattern assessment results potentially useful to perform other pattern recognition analysis (i.e. one or many layers of pattern analysis).

Examples of pattern recognition types that may be employed for this purpose include, without limitation, supervised learning 260, unsupervised learning 262, and reinforcement learning 264. Supervised learning 260 may comprise, for example, fraud or not fraud 266; unsupervised learning 262 may comprise, for example, segregation 268 and value of data 270; and reinforcement learning 264 may involve, for example, treatment order 272 and treatment timing 274. Thus, supervised learning 260 for embodiments of the invention may consist of a target/outcome/dependent variable, which may be predicted from a given set of predictors/independent variables. Using such variables, algorithms may be created that map inputs to desired outputs. The training process may continue until the model achieves a desired level of accuracy on the training data.

In embodiments of the invention, unique models may to be used for unique dependent variables. Control data may be withheld from the automated system for embodiments of the invention until training is complete in order to confirm the efficacy of the algorithms identified. In unsupervised learning 262 for embodiments of the invention the targets/outcomes may not be specified. In embodiments of the invention, unsupervised learning 262 may be used for clustering a population into different groups, such as segmenting customers, accounts, and/or activities into different groups for specific intervention and flow. In addition, embodiments of the invention may employ reinforcement learning 264, in which a machine is trained to make specific decisions by training itself continually using trial-and-error. Thus, the machine may learn from past experience and strive to capture a best possible knowledge to make accurate decisions.

Referring still again to FIG. 2, treatment execution 276 for embodiments of the invention may be a process of taking or withholding actions in order to resolve a case. Treatment execution 276 may comprise, for example, case categorization 278 as fraud 280 or not fraud 282, case processing 284 as no action 286, or automated 288, and communication/interaction tactics 290 as text 292, mobile push 294, phone call 296, email 298, or chat 299. Thus, treatment execution 276 for embodiments of the invention may be a process of taking or withholding actions in order to resolve a case. For example, there may be two possible case categorizations, namely fraud 280 or not fraud 282, and based upon the case categorization 278, there may be three possible actions to be taken, namely no action 286, automated interactions 288, and manual interactions 275.

In embodiments of the invention, automated and manual interactions may be performed mutually exclusively or together over time in series or in parallel. In manual interactions, personnel may perform actions in regard to an identified case, such as personnel communicating with clients/customers via one or many communication channels, personnel interacting with systems (e.g., notation, reading records, writing records, and updating records). In automated interactions, such actions may be performed by the automated system for embodiments of the invention in regard to the identified case. Automated interactions may include, without limitation, system-to-system interactions (e.g., notation, reading records, writing records, and updating records) and system communications with clients or customers via one or many communication channels (e.g. email, secure messaging, text messaging, interactive voice, mobile application, web, and chat).

Referring once more to FIG. 2, in embodiments of the invention, treatment results 277 may be final outcomes that have been identified regarding a particular case. Treatment results 277 also may be a feedback mechanism for the fraud risk assessment automation system for embodiments of the invention. Treatment results 277 may comprise, for example, case determination, such as fraud or not fraud identified 279; communication/interaction results 281, such as successful/unsuccessful contact 283, timing of response/interactions 285; review and analysis 287, such as success criteria review 289, pattern recognition thresholds 291, data inclusion/exclusion 293; and governance 295, such as accept and implement proposal 297 or refusal 299.

Thus, the treatment results process 277 may include, without limitation, case determination 279, case processing and communication/interaction results 281, post decision review and analysis 287, and governance 295. Case determination 279 may involve, for example, a determination of whether or not fraud was identified with an associated case. Case processing and communication/interaction results 281 may involve, for example, obtaining an efficacy of the fraud risk assessment automation system and the associated case processing actions. The consequences of treatment execution may be obtained and provided to the fraud risk assessment automation system for analysis and enhancement.

As noted, communication/interaction results 281 for embodiments of the invention may be “successful” 283 or “not successful” 285. In embodiments of the invention, a determination of whether or not fraud was identified with regard to a case may be obtained, and order, timing, inclusion, and exclusion of actions may be noted for incorporation into the fraud risk assessment automation system. Post decision review and analysis 287 may involve a comparison of an assessment of a case before results were identified with results of the case. An accuracy (e.g. fraud/not fraud, precision or confidence level), timing (i.e. throughput), order, inclusion, and exclusion of the actions for the case may be reviewed for potential enhancements. Some items that may be reviewed and analyzed include, without limitation, the system, process, workflow, and data elements.

Referring again to FIG. 2, governance 295 for embodiments of the invention may involve processes of interaction, decision-making, and controls regarding a formal acceptance 297 and implementation or refusal 299 of proposed changes to the fraud risk assessment automation system. In embodiments of the invention, a scope of governance 295 may include, without limitation, data elements used or excluded from use, processes to be used or excluded from use, definitions of data elements, definitions, creation, updates, and removal of algorithms, an order of processing, workflow enhancements, and model review.

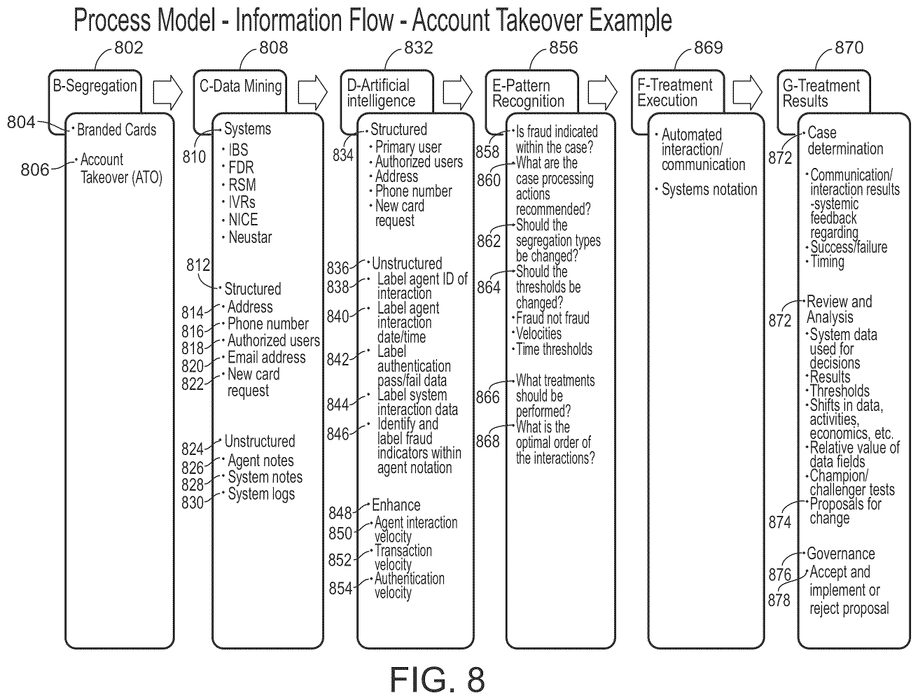

FIG. 8 is a schematic diagram that illustrates an example of a processing model in a simple use case of a possible account takeover in the automated system for embodiments of the invention. A use case example may relate to an account takeover example including phases, such as segregation 802, data mining 808, artificial intelligence 832, pattern recognition 856, treatment execution 869, and treatment result 870. Embodiments of the invention may employ machine learning to teach the system for embodiments of the invention over time from a pattern recognition perspective. As noted, system notes may refer to notations on an account itself, which provide a servicing history of the account, such as a servicing history all channels involved in client interactions with the business whether such channels are self-service, digital, mobile device, actual voice calls between the client and the business.

Referring to FIG. 8, a single segregation 802 path is provided to illustrate examples of activities that may be performed, data that may be obtained, and a manner in which results may be used and refined. It is to be understood that the example of FIG. 8 is not comprehensive in nature and represents a simple use case involving branded cards case 804 and account take over fraud 806. In a data mining process 808, all relevant data may be obtained from various systems 810 where available including, for example, other accounts of the existing card member to provide the most accurate and precise analysis. Such data may include, for example, structured data 812, such as address 814, phone number 816, authorized users 818, email address 820, and new card requests 822, and unstructured data 824, such as agent notes 826, system notes 828, and system logs 830.

Referring further to FIG. 8, artificial intelligence 832 may be employed to confirm that all structured data 834 is labeled and conforms to the required system communication protocols (e.g. formatting and data sanity checks). In addition, artificial intelligence 832 may also be employed to analyze unstructured data 836, for example, to label agent IDs of interactions 838, to label agent interaction dates/times 840, to label authentication pass/fail data 842, to label system interaction data 844, and to identify and label fraud indicators within agent notations 846.

Thus, in embodiments of the invention, artificial intelligence 832 may identify and label known data elements (e.g. agent interactions, timing of interactions, authentications), identify and label additional patterns that adhere to known data elements (e.g. notation X is an additional element that should be included in the identification and labeling of authentication interactions), and identify and label additional items that correlate to a specific activity and are not currently considered in pattern recognition. Referring further to FIG. 8, artificial intelligence 832 may also be used to enhance 848 the data elements to create metadata pattern recognition consideration. Such enhancements 848 may include, for example, agent interaction velocity 850, transaction velocity 852, and authentication velocity 854.

Referring again to FIG. 8, pattern recognition 856 may be used to answer questions with varying levels of confidence, which may be used to direct treatment execution. Such questions may include, for example, “Is fraud indicated within the case?” 858, “What are the case processing actions recommended?” 860, “Should the segregation types be changed?” 862, “Should the thresholds be changed (e.g., fraud, not fraud, velocities, time thresholds, transaction value thresholds) 864, “What treatments should be performed?” 866 and “What is the optimal order of the interactions?” 868. Multiple layers of pattern recognition 856 may be used to derive desired outputs. Referring still again to FIG. 8, treatment execution 869 may involve, for example, automated interaction and/or communication and systems notation.

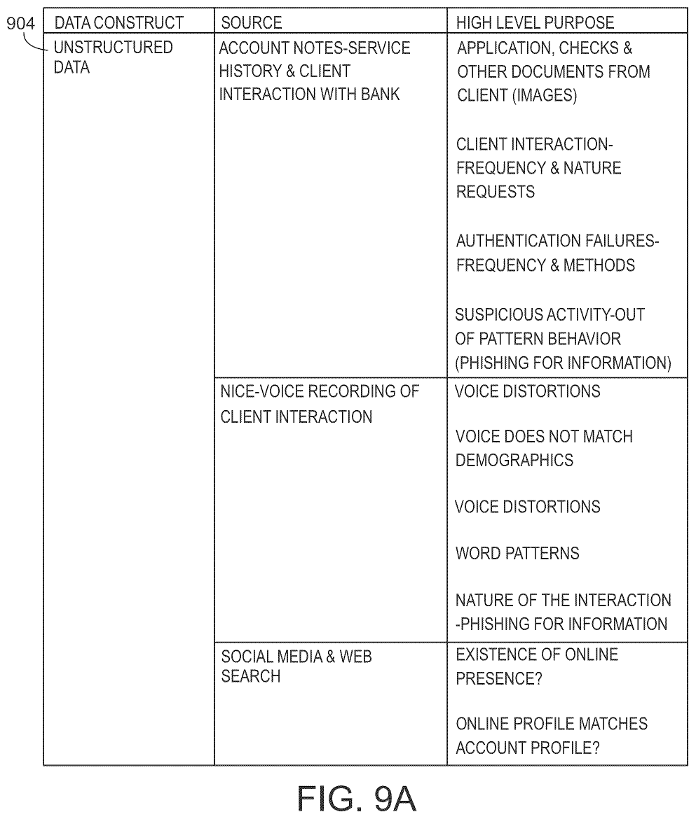

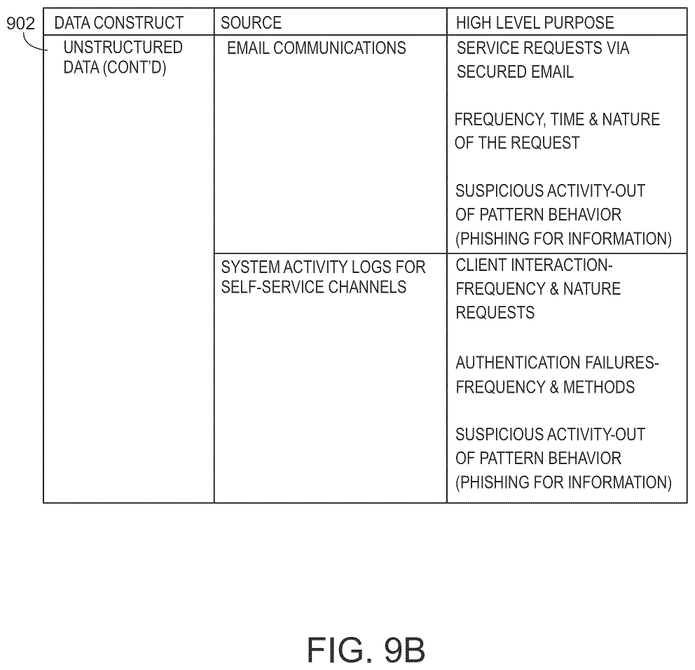

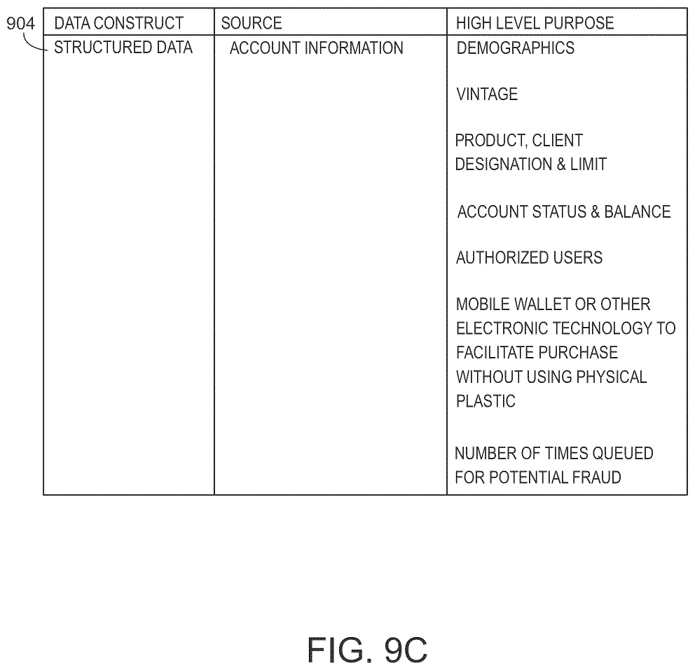

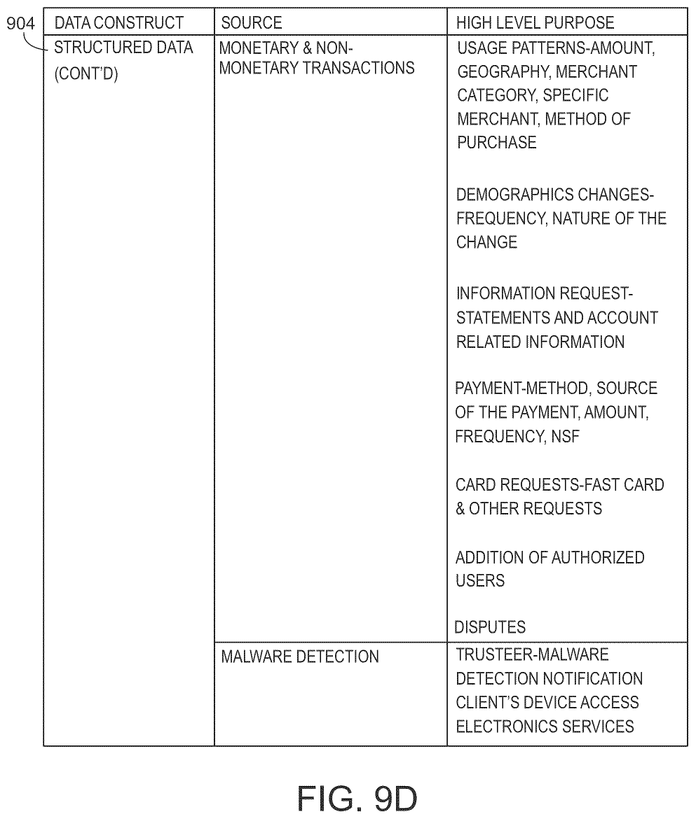

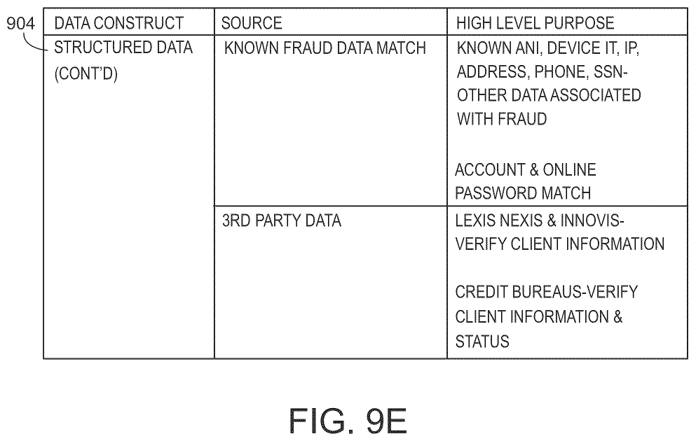

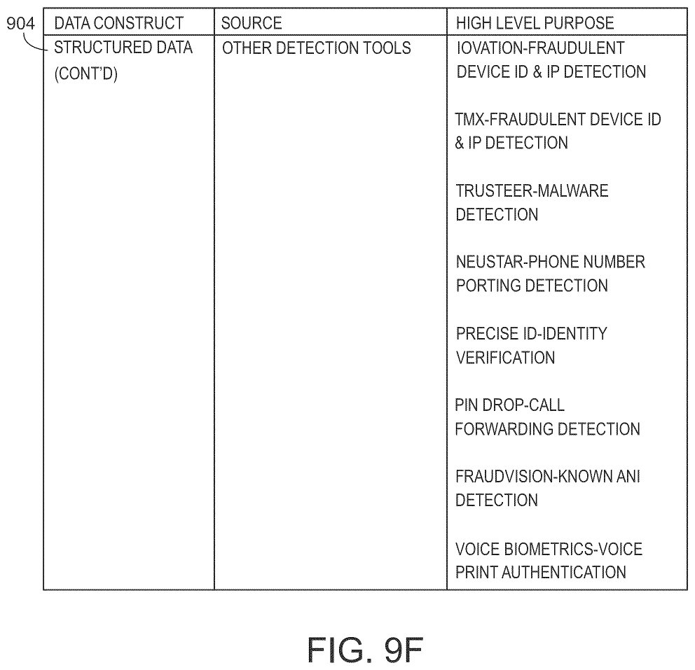

Referring again to FIG. 8, treatment results 870 may be used as a feedback loop for continual process improvement. A final determination 872 of the case may be used to systemically validate or improve portions of the fraud risk assessment automation system (e.g. pattern recognition), as well as to improve overall system enhancements. Referring again to FIG. 8, review and analysis 872 may be performed to determine responsiveness of systemic change to the economic environment, fraud activities, and non-systemic threshold optimization. Tests may be designed and executed to determine the efficacy of the recommended changes. Based upon the results of the executed tests, proposals 874 may be documented for recommended implementation, and governance 876 may occur to accept and implement or reject the proposed change 878. FIGS. 9A through 9F show a table that illustrates examples of unstructured data 902 and structured data 904 for mining and analysis by the automated system for embodiments of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The present invention may be a system, a method, and/or a computer program product at any possible technical detail level of integration. The computer program product may include a computer readable storage medium (or media) having computer readable program instructions thereon for causing a processor to carry out aspects of the present invention.

It is to be understood that embodiments of the invention may be implemented as processes of a computer program product, each process of which is operable on one or more processors either alone on a single physical platform or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

Aspects of the present invention may be described herein with reference to flowchart illustrations and/or block diagrams of methods, apparatus (systems), and computer program products according to embodiments of the invention. It will be understood that each block of such flowchart illustrations and/or block diagrams, and combinations of blocks in the flowchart illustrations and/or block diagrams, may be implemented by computer readable program instructions. These computer readable program instructions may be provided to a processor of a special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures may illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-20. (canceled)

21. A system for account fraud detection, comprising:
one or more processors coupled to memory, the one or more processors being programmed to executes application code instructions that are stored in a storage device, the application code instructions cause the one or more processors to:
create models of accounts based on machine learning process using inputs of data related to fraudulent account events and non-fraudulent account events;
receive data regarding a potential fraudulent account event from a fraud detection platform processor;
segregate the data regarding the potential fraudulent account event into (1) a portfolio type grouping comprising at least one of branded cards type, retail services type, or retail bank type and (2) a fraud type grouping comprising at least one of account takeover fraud type, never received issues fraud type, transaction fraud type, or identification fraud type;
extract additional data related to the potential fraudulent account event from plurality of sources using intelligence search engines based on the models created by the machine learning process;
generate metadata elements to encode with one or more instances of the additional data based on characteristics and data patterns of the additional data;
search the additional data and the metadata elements for one or more data patterns that indicate whether or not the potential fraudulent account event is fraudulent;
identify a resolution path based on a search result, wherein at least one data pattern is found that indicates that the potential fraudulent account event is fraudulent;
identify a final result of the potential fraudulent account event; and
input the final result into the machine learning process to further train the machine learning process.

22. The system of claim 21, wherein the application code instructions cause the one or more processors to extract the additional data related to the potential fraudulent account event comprising structured data and unstructured data related to the potential fraudulent account event from the plurality of sources.

23. The system of claim 22, wherein the application code instructions cause the one or more processors to extract the structured data related to the potential fraudulent account event comprising labeled data from at least one of said plurality of sources.

24. The system of claim 23, wherein the application code instructions cause the one or more processors to extract the structured data related to the potential fraudulent account event comprising at least one of address change data, phone number data, authorized transfer data, mail address data, and new card request data from the plurality of sources.

25. The system of claim 22, wherein the application code instructions cause the one or more processors to extract said unstructured data related to the potential fraudulent account event comprising at least one of agent notes, system notes, and system logs from the plurality of sources.

26. The system of claim 21, wherein the application code instructions cause the one or more processors to extract the additional data related to the potential fraudulent account event from the plurality of sources comprising at least one of credit reporting agency data systems, interactive voice response services systems, account activity data, customer records, transaction records, agent notes, and system notes.

27. The system of claim 21, wherein the application code instructions cause the one or more processors to search the data and the additional data for the one or more data patterns comprising patterns of dates and times of notations of account activity over a pre-determined period that indicate that the potential fraudulent account event is fraudulent.

28. A method for account fraud detection, the method comprising:
creating models of accounts based on machine learning process using inputs of data related to fraudulent account events and non-fraudulent account events;
receiving data regarding a potential fraudulent account event from a fraud detection platform processor;
segregating the data regarding the potential fraudulent account event into (1) a portfolio type grouping comprising at least one of branded cards type, retail services type, or retail bank type and (2) a fraud type grouping comprising at least one of account takeover fraud type, never received issues fraud type, transaction fraud type, or identification fraud type;
extracting additional data related to the potential fraudulent account event from plurality of sources using intelligence search engines based on the models created by the machine learning process;
generating metadata elements to encode with one or more instances of the additional data based on characteristics and data patterns of the additional data;
searching the additional data and the metadata elements for one or more data patterns that indicate whether or not the potential fraudulent account event is fraudulent;
identifying a resolution path based on a search result, wherein at least one data pattern is found that indicates that the potential fraudulent account event is fraudulent;
identifying a final result of the potential fraudulent account event; and
inputting the final result into the machine learning process to further train the machine learning process.

29. The method of claim 28, further comprising extracting the additional data related to the potential fraudulent account event comprising structured data and unstructured data related to the potential fraudulent account event from the plurality of sources.

30. The method of claim 29, further comprising extracting the structured data related to the potential fraudulent account event comprising labeled data from at least one of said plurality of sources.

31. The method of claim 30, further comprising extracting the structured data related to the potential fraudulent account event comprising at least one of address change data, phone number data, authorized transfer data, mail address data, and new card request data from the plurality of sources.

32. The method of claim 29, further comprising extracting said unstructured data related to the potential fraudulent account event comprising at least one of agent notes, system notes, and system logs from the plurality of sources.

33. The method of claim 28, further comprising extracting the additional data related to the potential fraudulent account event from the plurality of sources comprising at least one of credit reporting agency data systems, interactive voice response services systems, account activity data, customer records, transaction records, agent notes, and system notes.

34. The method of claim 28, further comprising searching the data and the additional data for the one or more data patterns comprising patterns of dates and times of notations of account activity over a pre-determined period that indicate that the potential fraudulent account event is fraudulent.

35. One or more non-transitory computer-readable media storing instructions thereon, wherein the instructions cause one or more processors to perform operations comprising:
creating models of accounts based on machine learning process using inputs of data related to fraudulent account events and non-fraudulent account events;
receiving data regarding a potential fraudulent account event from a fraud detection platform processor;
segregating the data regarding the potential fraudulent account event into (1) a portfolio type grouping comprising at least one of branded cards type, retail services type, or retail bank type and (2) a fraud type grouping comprising at least one of account takeover fraud type, never received issues fraud type, transaction fraud type, or identification fraud type;
extracting additional data related to the potential fraudulent account event from plurality of sources using intelligence search engines based on the models created by the machine learning process;
generating metadata elements to encode with one or more instances of the additional data based on characteristics and data patterns of the additional data;
searching the additional data and the metadata elements for one or more data patterns that indicate whether or not the potential fraudulent account event is fraudulent;
identifying a resolution path based on a search result, wherein at least one data pattern is found that indicates that the potential fraudulent account event is fraudulent;
identifying a final result of the potential fraudulent account event; and
inputting the final result into the machine learning process to further train the machine learning process.

36. The one or more non-transitory computer-readable media of claim 35, further comprising extracting the additional data related to the potential fraudulent account event comprising structured data and unstructured data related to the potential fraudulent account event from the plurality of sources.

37. The one or more non-transitory computer-readable media of claim 36, further comprising extracting the structured data related to the potential fraudulent account event comprising labeled data from at least one of said plurality of sources.

38. The one or more non-transitory computer-readable media of claim 37, further comprising extracting the structured data related to the potential fraudulent account event comprising at least one of address change data, phone number data, authorized transfer data, mail address data, and new card request data from the plurality of sources.

39. The one or more non-transitory computer-readable media of claim 36, further comprising extracting said unstructured data related to the potential fraudulent account event comprising at least one of agent notes, system notes, and system logs from the plurality of sources.

40. The one or more non-transitory computer-readable media of claim 35, further comprising extracting the additional data related to the potential fraudulent account event from the plurality of sources comprising at least one of credit reporting agency data systems, interactive voice response services systems, account activity data, customer records, transaction records, agent notes, and system notes.
